(19) United States
(12) Patent Application Publication
(10) Pub. No.: US 2006/0067735 A1
(43) Pub. Date: Mar. 30, 2006

(54) Developer storing container and connecting member

(75) Inventors: Yoshiaki Sanada, Ikoma-shi (JP); Hisashi Kunihiro, Nara-shi (JP); Koichi Mihara, Fujiidera-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/233,020

(22) Filed: Sep. 23, 2005

(30) Foreign Application Priority Data
Sep. 30, 2004 (JP) 2004-288487

(51) Int. Cl. G03G 15/08

(52) U.S. Cl. 399/120

(57) ABSTRACT

In a developer-storing container of the present invention, an agitation blade used in a toner-storing section and an agitation blade used in a waste-toner-storing section are coupled by a rotor. The rotor is interdigitated to a bearing mounted on a partition wall. The partition wall is made to be a fixed wall so that precision of interdigitation of the agitation blade of the toner-storing section, the rotor, and the agitation blade of the waste-toner-storing section is improved. Consequently, a developer-storing container that is easy to assemble and in which precision of interdigitation is high is realized.

This Nonprovisional application claims priority under 35 U.S.C. § 119(a) on patent application Ser. No. 288487/2004 filed in Japan on Sep. 30, 2004, the entire contents of which are hereby incorporated by reference.

### FIELD OF THE INVENTION

The present invention relates to a developer-storing container storing and agitating developer that is to be supplied to a developing tank of an image forming apparatus.

### BACKGROUND OF THE INVENTION

Many image forming apparatuses such as copying machines include a developer-storing container that supplies a developing tank with developer. Japanese Unexamined Patent Publication No. 2001-356577 (published on Dec. 26, 2001) discloses a particle-storing container in which an agitation member is taken in/out from a large aperture section disposed at the top of the inner part of the container, the agitation member is easy to mount on the main body of the container, and the agitation member is easy to take out from the container for re-use.

Japanese Unexamined Patent Publication No. 2003-337465 (published on Nov. 28, 2003) discloses a toner cartridge that is detachably mounted on an image forming apparatus. In the toner cartridge, an agitation member for agitating toner which fills the toner cartridge is slidably mounted in an axial direction. Upon insertion into the image forming apparatus, the agitation member contacts a pressing member disposed on the side close to the image forming apparatus so as to be slidden to an in-use position that is different from a not-in-use position.

Japanese Unexamined Patent Publication No. 2001-109244 (published on Apr. 20, 2001) discloses a development apparatus in which an agitation section is composed of connection sections that connects adjoining agitation members, the agitation members divided into a plurality of members along the axial direction having the same shape, and a restraint section disposed in a development container to restrain the connection section. The development apparatus rotates, upon receiving drive, to supply a development roller with developer in the development container.

FIG. 5 shows a cross section that illustrates a physical relationship between a toner cartridge 101 that is a conventional developer-storing container included in a copying-machine and a developing tank 102.

The toner cartridge 101 contains toner that has developer inside, and the toner is agitated by an agitation blade 101a. The toner cartridge 101 supplies the developing tank 102 with the toner through a supply opening 102a by using a supply roller 101b. In the developing tank 102, the supplied toner is agitated by an agitation roller 102b and is sent to an agitation roller 102c. The agitation roller 102c agitates the supplied toner and sends it to a development roller 102d. A doctor blade 102e is mounted above the development roller 102d and controls the thickness of the layer of toner on the development roller 102d. This allows the development roller 102d to supply a photoconductor 103 with a certain amount of toner. Further, a toner sensor 102f is mounted below the agitation roller 102c in the developing tank 102. The toner sensor 102f detects a residual amount of toner in the developing tank 102.

FIG. 6 shows a cross section of the toner cartridge 101 along a shaft of the photoconductor 103. The toner cartridge 101 includes a toner-storing section 111 and a waste-toner-storing section 112. A core cylinder 101d partitions space in the toner cartridge 101 such that the toner-storing section 111 and the waste-toner-storing section 112 are adjacent to each other in the direction the shaft extends (axial direction). The toner-storing section 111 is a section that stores toner to be supplied to the developing tank 102. The toner-storing section 111 includes the agitation blade 101a. The waste-toner-storing section 112 is a section that stores residual toner that was not transferred to an image in an image-forming process and was retrieved. The waste-toner-storing section 112 includes an agitation blade 101c.

In order to assemble the agitation blade 101a and the agitation blade 101c in the housing, the core cylinder 101d is detachably mounted in the housing of the toner cartridge 101. The agitation blade 101a, the agitation blade 101c, and the core cylinder 101d are constructable and deconstructable in the housing. A bearing 101e is mounted on an end section of housing of the toner cartridge 101 that is on the side close to the toner-storing section 111. A bearing 101f is mounted on the core cylinder 101d. A bearing 101g is mounted on an end section of housing of the toner cartridge 101 that is on the side close to the waste-toner-storing section 112. The agitation blade 101a includes a flange 101h on an axial end section on the side close to the bearing 101e. The flange 101h is connected by the bearing 101e to the driving shaft system 113 that transmits driving force from the outside of the toner cartridge 101. The driving shaft system 113 includes a clutch and a gear that transmit driving force from a motor. A sponge 101j acting as a sealing member is mounted in between the flange 101h and the housing. Further, the agitation blade 101a includes a flange 101i on an axial end section on the side close to the bearing 101f. The flange 101i is connected by the bearing 101f to an axial end section of the agitation blade 101c that is on the side close to the bearing 101f. A sponge 101k acting as a sealing member is mounted in between the flange 101i and the core cylinder 101d. An axial end section of the agitation blade 101c that is on the side close to the bearing 101g is supported by the bearing 101g. This allows an axle of the agitation blade 101a and an axle of the agitation blade 101c to be connected to each other in such a way that the axles form one axle.

However, in the conventional structure of the toner cartridge 101 described above, the agitation blade 101a, the agitation blade 101c, and the core cylinder 101d are constructable and deconstructable in the housing. Accordingly, in order to absorb dimensional distortion of the members due to assembly, each member is designed in such a way that some deviation is allowed in its dimensions so as to be easily assembled. Therefore, the members are loosely interdigitated with each other. Consequently, problems may arise in which sufficient driving force for rotating the agitation blades 101a and 101c is not transmitted to the toner cartridge 101, or in which toner leaks and solidifies in a gap between the bearings 101e, 101f, and 101g and the axle.

### SUMMARY OF THE INVENTION

The present invention is in view of the conventional problems described above and has as an object to realize a developer-storing container that is easy to assemble and in which assembly dimensions of members are precise enough for the members to be closely interdigitated to each other.

A developer-storing container includes a developer-storing section including a developer agitation member that rotates to agitate developer, and a waste-developer-storing section including a waste-developer agitation member that rotates to agitate waste-developer, an axle of the developer agitation member and an axle of the waste-developer agitation member being coupled so as to form one axle, and the developer-storing section and the waste-developer-storing section being formed so as to be adjacent to each other in a direction of the axle. In order to achieve the above object, a developer-storing container in connection with the above structure is characterized in that the developer-storing section and the waste-developer-storing section are formed by being partitioned by a fixed wall, fixed to a housing of the developer-storing container in such a way as to be adjacent to each other in the direction of the axle, and the developer agitation member and the waste-developer agitation member are constructably and deconstructably coupled to each other by a connecting member that is slidably, rotatably and detachably interdigitated to a bearing formed on the fixed wall.

Further, in order to achieve the above object, a developer-storing container in connection with the present invention is characterized in that the developer-storing container includes: a fixed wall, fixed to the developer-storing container and partitioning a developer-storing section that includes a developer agitation member that rotates to agitate developer, and a waste-developer-storing section that includes a waste-developer agitation member that rotates to agitate waste-developer; and a connecting member that is slidably, rotatably, and detachably interdigitated to the bearing formed on the fixed wall, the developer agitation member and the waste-developer agitation member being detachably interdigitated to the connecting member, respectively, and an axle of the developer agitation member, an axle of the connecting section, and an axle of the waste-developer agitation member forming one axle.

In the above structure, assembly is carried out by interdigitating a connecting member to a fixed wall so that the developer agitation member and the waste-developer agitation member are coupled. Using the fixed wall makes it easy to assemble the developer-storing container. Further, using a fixed wall makes it possible to assemble the connecting member in a precise position, and therefore the developer agitation member and the waste-developer agitation member are also assembled at precise positions.

Consequently, a developer-storing container that is easy to assemble and in which assembly dimensions of members are precise enough for the members to be closely interdigitated to each other is realized.

For a fuller understanding of the nature and advantages of the invention, reference should be made to the ensuing detailed description taken in conjunction with the accompanying drawings.

### BRIEF DESCRIPTION OF THE DRAWINGS

FIG. 1 illustrates an embodiment of the present invention. It is a cross section illustrating a structure of substantial part of a toner cartridge.

FIG. 2 is a figure illustrating in detail a structure of a rotor included in the toner cartridge in FIG. 1.

FIG. 3 is a figure illustrating in detail a structure of a press-fit member included in the toner cartridge in FIG. 1.

FIG. 4 is a figure illustrating in detail a structure of a crown-shaped flange and sealing member both of which are included in the toner cartridge in FIG. 1.

FIG. 5 illustrates conventional art and is a cross section illustrating a structure around a developing unit of an image forming apparatus including a toner cartridge.

FIG. 6 illustrates conventional art and is a cross section illustrating a structure of a substantial part of a toner cartridge.

### DESCRIPTION OF THE EMBODIMENTS

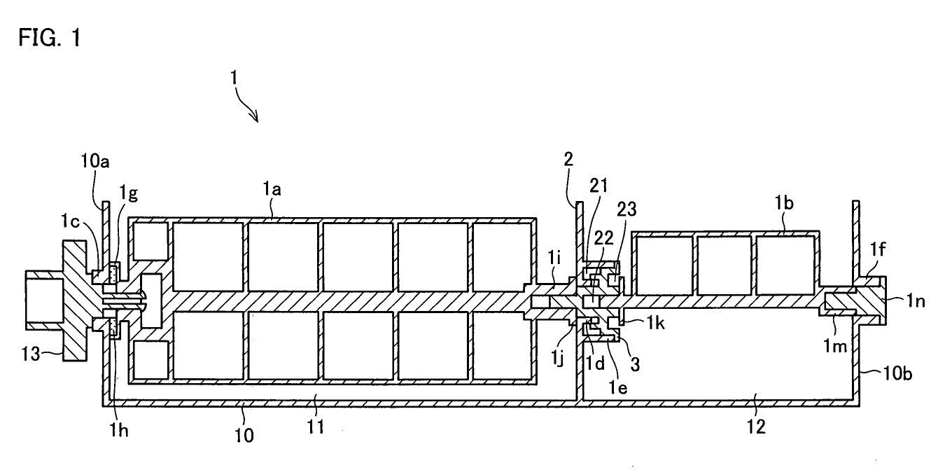

The following describes an embodiment of the present invention, with reference to FIGS. 1 to 4.

FIG. 1 illustrates a structure of a toner cartridge (developer-storing container) 1 in connection with the embodiment. This figure is a cross section along an axle of the photoconductor.

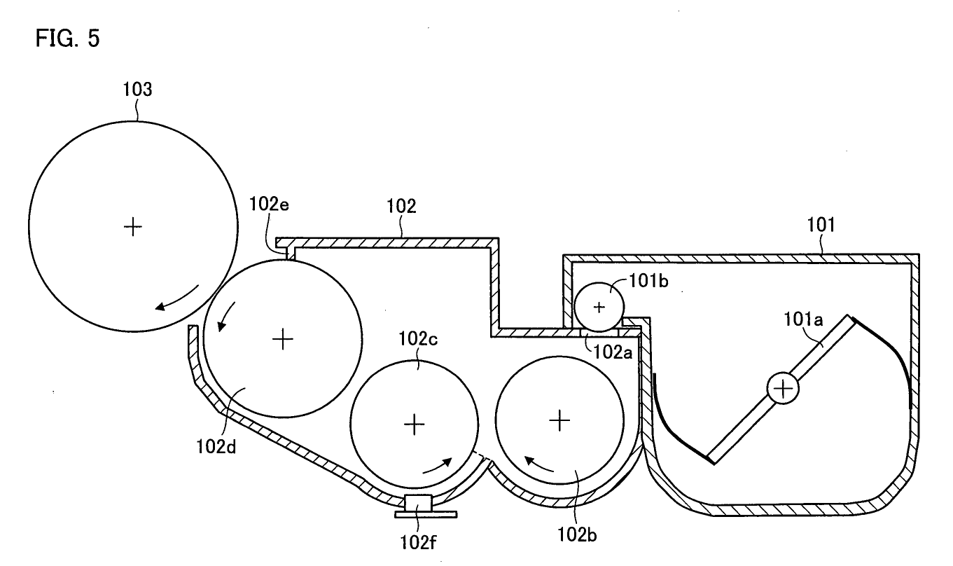

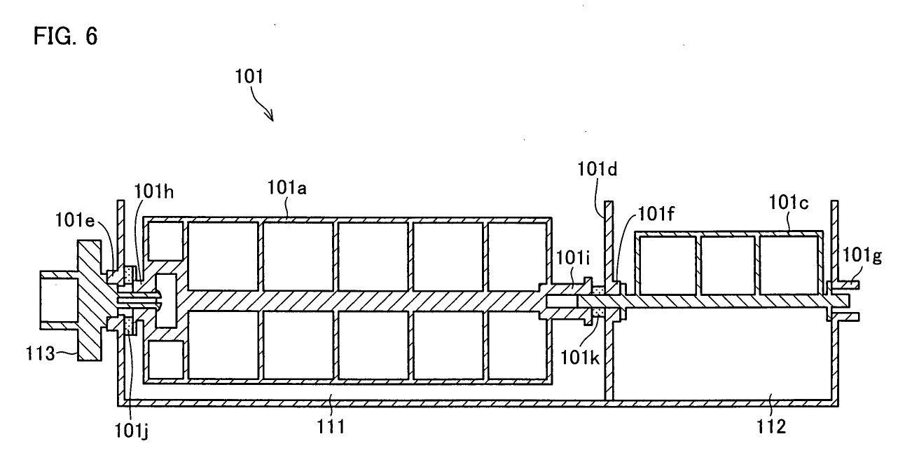

The toner cartridge 1 includes a toner-storing section (developer-storing section) 11 and a waste-toner-storing section (waste-developer-storing section) 12. The toner-storing section 11 and the waste-toner-storing section 12 are formed with a partition wall (fixed wall) 2 partitioning the housing 10 of the toner cartridge 1. The toner-storing section 11 and the waste-toner-storing section 12 are adjacent to each other in the direction of the axle described below. The partition wall 2 forms a part of the housing 10 of the toner cartridge 1 and is fixed to the housing 10. The toner-storing section 11 includes an agitation blade (developer agitation member) 1a. The agitation blade la is formed of a flat, lattice-shaped frame having an axle in its core. The agitation blade 1a rotates about the axle to agitate toner (developer) that is to be supplied to a developing tank included in the toner-storing section 11. The waste-toner-storing section 12 includes an agitation blade (waste-developer agitation member) 1b. The agitation blade 1b is formed of a flat, lattice-shaped frame having an axle at one side. The agitation blade 1b rotates about the axle to agitate residual toner that was not transferred in an image forming process and was retrieved to the waste-toner-storing section 12. An agitation sheet that slides with respect to an inner wall of the housing may be mounted on end sections of the agitation blades 1a and 1b that are in the direction of the diameter of the rotation, similar to the agitation blade 101a of the toner cartridge 101 as illustrated in FIG. 5, described above. The axle of the agitation blade 1a and the axle of the agitation blade 1b are coupled to each other in such a way that the axles form one axle. The axles are parallel to the axle of the photoconductor.

A bearing 1c that extends outwardly from the housing 10 is formed on a wall 10a of the housing 10 that is opposite to the partition wall 2 with respect to the agitation blade 1a. Bearings 1d and 1e, which extend toward the waste-toner-storing section 12, are formed on the partition wall 2. An axle-hole section 1f is formed on a wall 101b of the housing 10 that is opposite to the partition wall 2 with respect to the agitation blade 1b.

The agitation blade 1a includes a flange 1g on an end section of the axle that is on the side closer to the wall 10a. The flange 1g is connected to a driving shaft system 13 that transmits driving force from outside of the toner cartridge 1 through the bearing 1c. The driving shaft system 13 includes a clutch and a gear that transmits driving force from a motor. A sealing member 1h that prevents leakage of toner to the outside of the housing is mounted in between the flange 1g and the wall 10a. Besides sponge, films, such as polyester films, may be used as the sealing member 1h. The agitation blade 1a includes, on an end section of the axle that is closest to the partition wall 2, a cylindrical-shaped flange 1i having an end section with an aperture. An axle of the rotor (connecting member) 3 is inserted partially into the cylindrical-shaped part of the flange 1i so that the agitation blade la is connected to the flange 1i. A sealing member 1j such as sponge or film that prevents migration of toner to the waste-toner-storing section 12 is mounted in between the flange 1i and the partition wall 2. The rotor 3 is interdigitated to the bearings 1d and 1e from the side close to the waste-toner-storing section 12. The rotor 3 is slidable and rotatable with respect to the bearings 1d and 1e and is detachable. An end section of the axle of the agitation blade 1b that is on the side close to the partition wall 2 of the agitation blade 1b is connected to the rotor 3 in such a way that the axle is partially interdigitated to the rotor 3. The agitation blade 1b includes a flange 1k on an end section of the axle that is close to the partition wall 2. The flange 1k is in contact with the closest end section of the rotor 3 to the wall 10b. The contact of the flange 1k makes it possible to sustain thrust load applied to the agitation blade 1b toward the partition wall 2. The agitation blade 1b further includes a flange lm on an axle-end section on the end of the axle closest to wall 10b. The flange lm is a cylindrical flange whose end section has an aperture. A press-fit member (axle-supporting member) 1n is inserted into an axle-hole of the axle-hole section 1f from the outside of the wall 10b. A part of press-fit member 1n that extends toward the inner part of the waste-toner-storing section 12 is inserted in the cylinder of the flange 1m. The press-fit member 1n is fixed to the wall 10b. The flange lm slides and rotates about the press-fit member 1n.

In the manner described above, the agitation blade 1a and the agitation blade 1b are coupled by the rotor 3, and the axle of the agitation blade 1a and the axle of the agitation blade 1b form one axle.

As previously described, in the embodiment, the toner agitation blade 1a and the waste-toner agitation blade 1b are coupled by the rotor 3 in such a way as to be constructable and deconstructable. In this manner, the rotor 3 is interdigitated to the partition wall 2, which is a fixed wall, and the toner agitation blade la and the waste-toner agitation blade 1b are assembled by coupling, thereby easily assembling the toner cartridge 1 with the fixed wall. In addition, using a fixed wall makes it possible to assemble the rotor 3 at a precise position, thereby assembling the toner agitation blade 1a and the waste-toner agitation blade 1b at precise positions.

Accordingly, it is not necessary to design the members in a conventional way in which the dimensions of members include a wide margin for absorbing dimensional errors in assembly of the members. This eliminates looseness in interdigitation of assembled members. As a result, sufficient driving force for rotating the agitation blades 1a and 1b is transmitted to the toner cartridge 1, and it becomes difficult for toner to migrate to gaps between respective bearings and the axle. Therefore, a problem of solidification of toner in the gaps is less likely to occur.

The foregoing makes it possible to realize a developer-storing container that is easy to assemble and in which assembly dimensions of members are precise enough for the members to be closely interdigitated to each other.

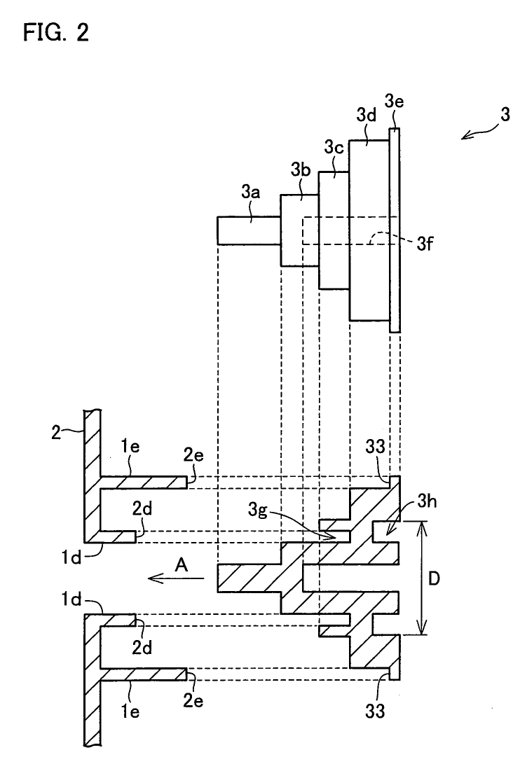

The following describes a structure of the rotor 3 of the toner cartridge 1 in the above structure, with reference to FIG. 2. The upper diagram in FIG. 2 is a side view of the rotor 3. The diagram below the side view is a cross section of the rotor 3 along the axle. The diagram on the left of the cross section is a cross section of the bearings 1d and 1e. The length of extension of the bearing 1e toward the waste-toner-storing section 12 is set to be longer than the length of extension of the bearing 1d.

As illustrated in the upper diagram in FIG. 2, the rotor 3 includes an axle 3a, a cylindrical section 3b, a cylindrical section 3c, a cylindrical section 3d, and a flange 3e, in the order as listed. Each of them is concentric on a cross section perpendicular with respect to the direction along the axle, and the respective radii increase in the order as listed above. An axle-hole 3f is formed in the rotor 3 from the flange 3e partway into the cylindrical section 3b. An axle of the agitation blade 1b is partially inserted into a part of the axle-hole 3f.

The axle 3a is a section extending toward the toner-storing section 11. As described above, the axle 3a is interdigitated to the flange 1i of the agitation blade 1a. The cylindrical section 3b, as illustrated in the diagram below the side view in FIG. 2, is a cylindrical section having the axle-hole 3f forming a hollow. An end section of the cylindrical section that is on the side near the partition wall 2 is closed. When the rotor 3 is interdigitated to the bearings 1d and 1e, the cylindrical side face of the cylindrical section 3b is supported by the bearing 1d. The inner face of the bearing 1d bears a radial load from the cylindrical section 3b. The cylindrical section 3c is a cylindrical section having a gap 3g created at an external position whose diameter is wider than the diameter of the cylindrical section 3b (referred to as “first external gap 3g”, hereinafter), and having the axle-hole 3f forming a hollow. An end section of the first external gap 3g on the side close to the partition wall 2 has an aperture. When the rotor 3 is interdigitated to the bearings 1d and 1e in the direction of arrow A in the figure, the face 2d of the bearing id that faces towards the rotor 3, is positioned short of the first external gap. Therefore, the first external gap 3g remains as a hollow. The cylindrical section 3d is a cylindrical section having a gap 3h created at an external position whose diameter is wider than the inner diameter of the first external gap 3g of the cylindrical section 3b (referred to as “second external gap 3h”, hereinafter), and the axle-hole 3f forms a hollow. An end section that is on the side close to the partition wall 2 is exposed outside and is closed. When the rotor 3 is interdigitated to the bearings 1d and 1e, the cylindrical side face of the cylindrical section 3d is supported by the bearing 1e, thereby the inner face of the bearing 1e bears radial load from the cylindrical section 3d. Further, an external diameter D of the second external gap 3h is set to be wider than the diameter of the flange 1k of the agitation blade 1b. The diameter of the axle-hole 3f is set to be smaller than the diameter of the flange 1k. The flange 3e is a flange having the second external place and the axle-hole 3f that are through-holes. When the rotor 3 is interdigitated to the bearings 1d and 1e, the face 33, which is created at an external position whose diameter is wider than the diameter of the cylindrical section 3d of the flange 3, is in contact with the plane 2e of the bearing 1e that faces towards the rotor 3, thereby the plane 2e bears a thrust load from the flange 3e.

Due to the above structure of the rotor 3 and the bearings 1d and 1e, a space 21 is formed between and surrounded by the partition wall 2 and the rotor 3, that is, between the bearing 1d, the bearing 1e, the partition wall 2 between the bearings 1d and 1e, and cylindrical sections 3c and 3d (see FIG. 1). The space 21 includes the external gap 3g. Further, a space 22 surrounded by an inner wall of the axle-hole 3f and the axle of the agitation blade 1b is formed (see FIG. 1). Further, a space 23 substantially surrounded by the cylindrical section 3d, the flange 3e, and the flange 1k of the agitation blade 1b is formed (see FIG. 1). The space 23 is identical to the second external gap 3h. The spaces 22 and 23 are spaces other than a space occupied by the axle and having an aperture on a side opposite to the side closest to the partition wall 2, and are created inside of the rotor 3, on a waste-toner-storing section 12 side.

The spaces 21 to 23 may be made to act as pools of toner. Even if toner migrates to the gap between the rotor 3 and the partition wall 2, the toner can be led to the space 21. In the space 21, mainly toner that has leaked from the toner-storing section 11 is pooled, thereby preventing solidification of toner in the gap between the rotor 3 and the partition wall 2. Further, even if toner migrates to the gap between the rotor 3 and the axle of the agitation blade 1b, the toner can be led to the spaces 22 and 23, thereby preventing solidification of toner in the gap between the rotor 3 and the axle of the agitation blade 1b.

In the embodiment, the rotor 3 is interdigitated to the bearings 1d and 1e of the partition wall 2 from the side close to the waste-toner-storing section 12, but the bearings 1d and 1e may be structured oppositely to FIG. 1 with respect to the partition wall 2 so that the rotor 3 is interdigitated to the bearings 1d and 1e of the partition wall 2 from the side close to the toner-storing section 11. In this case, the spaces 21 to 23 are formed on the side close to the toner-storing section 11.

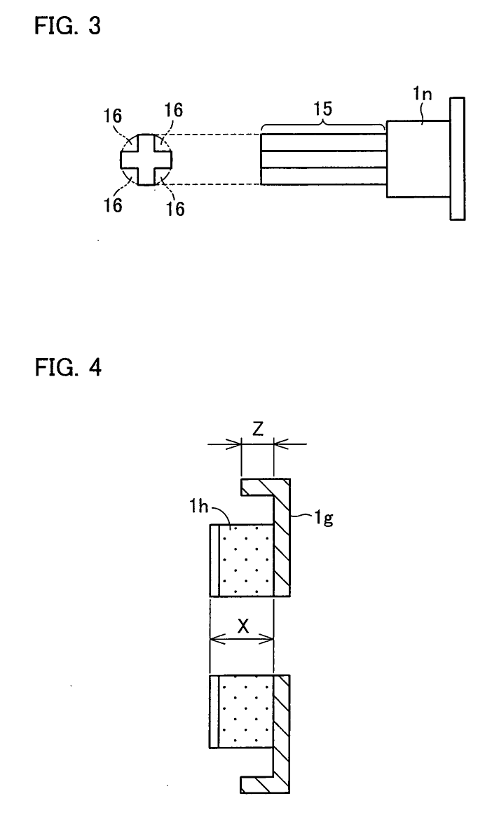

The following describes a structure of the press-fit member 1n of the toner cartridge 1 in the above structure, with reference to FIG. 3.

The diagram on the right in FIG. 3 is a side view of the press-fit member 1n. The diagram on the left in FIG. 3 is a diagram showing a top-end section on the press-fitting side (press-fit section 15 described below) of the press-fit member 1n in the direction opposite to the direction of press-fitting. The press-fit member 1n includes a press-fit section 15 that extends to the inner part of the waste-toner-storing section 12 while being interdigitated to the axle-hole section 1f from the outside of the wall 10b. The press-fit section 15 is a part that is to be inserted into the flange 1m. Grooves 16 . . . are axially formed on a surface of the press-fit section 15. In the figure, four grooves 16 . . . are formed in such a way that a section that is perpendicular to the axle of the press-fit section 15 forms a cross-shape. Forming such grooves 16 . . . allows the press-fit member 1n to be partially in contact with an inner face of the flange 1m. In this structure, a space is created between the inner face of the flange 1m and the press-fit member 1n acting as an axle-supporting member, thereby making the space act as a pool of toner. Therefore, even if toner migrates in between the inner face of the flange 1m and the press-fit member 1n, the toner can be led to the space, thereby preventing solidification of toner in a narrow gap. Any number of the grooves 16 . . . may be provided.

The following describes structures of the flange 1g and the sealing member 1h of the toner cartridge 1 in the above structure, with reference to FIG. 4.

FIG. 4 is a cross section along the axis of the flange 1g and the sealing member 1h. The flange 1g is crown-shaped having an external extension whose length is indicated as Z, on the side close to the wall 10a. The sealing member 1h is sandwiched by a flange face of the flange 1g and the wall 10a of the housing 10. When the axle of the agitation blade 1a moves in a direction of thrust, the sealing member 1h expands and contracts in the same direction. The length Z of the extension is set to be less than the axial thickness X of the sealing member 1h. Because of presence of the extension, when the sealing member 1h is pressed by the agitation blade 1a toward the wall 10a, the sealing member 1h is partially compressed, but not beyond the length Z of extension of the flange 1g. The sealing member 1h fulfils a sealing function upon being compressed in the direction of thrust. By setting dimensions as described above, over-compression of the sealing member 1h can be prevented. In addition, precision of the position of the agitation member la in the direction of thrust is improved.

As described above, a developer-storing container includes a developer-storing section including a developer agitation member that rotates to agitate developer, and a waste-developer-storing section including a waste-developer agitation member that rotates to agitate waste-developer, an axle of the developer agitation member and an axle of the waste-developer agitation member being coupled so as to form one axle, and the developer-storing section and the waste-developer-storing section being partitioned in such a way as to be adjacent to each other in a direction of the axle. In order to achieve the above object, a developer-storing container in connection with the above structure is characterized in that the developer-storing section and the waste-developer-storing section are formed by being partitioned by a fixed wall that is fixed to a housing of the developer-storing container in such a way that the developer-storing section and the waste-developer-storing section are adjacent to each other in the direction of the axle, and the developer agitation member and the waste-developer agitation member are constructably and deconstructably coupled to each other by a connecting member that is slidably, rotatably and detachably interdigitated to a bearing formed on the fixed wall.

In the above structure, assembly is carried out by interdigitating a connecting member to a fixed wall so that the developer agitation member and the waste-developer agitation member are coupled. Using the fixed wall makes it easy to assemble the developer-storing container. Further, using a fixed wall ensures that the connecting member is assembled at a precise position, and therefore the developer agitation member and the waste-developer agitation member are also assembled at precise positions.

Consequently, a developer-storing container that is easy to assemble and in which assembly dimensions of members are precise enough for the members to be closely interdigitated to each other is realized.

Further, in addition to the above structure, a developer-storing container of the present invention may be one in which: the waste-developer agitation member includes a cylindrical flange whose end section has an aperture, on an end section of the axle that is opposite to an end close to the fixed wall; an axle-supporting member that is interdigitated to an axle-hole formed on a wall of the housing of the developer-storing container, and is mounted in such a way as to extend to an inner part of the waste-developer-storing section, is inserted in the cylindrical flange; the axle-supporting member is fixed to the wall of the housing, and the cylindrical flange slides and rotates about the axle-supporting member; and an axial groove is formed on a part of the axle-supporting member that is to be inserted into the cylindrical flange so that the axle-supporting member is partially in contact with the inner face of the cylindrical flange.

In the above structure, the cylindrical flange of the waste-developer agitation member slides and rotates about the axle-supporting member. A space is created with the grooves between the inner face of the cylindrical flange and the axle-supporting member. The space can be made to act as a pool of toner. Therefore, even if toner migrates in between the cylindrical flange and the axle-supporting member, the toner can be led to the space, thereby preventing solidification of toner in a narrow gap.

Further, in addition to the above structure, a developer-storing container of the present invention may be one in which the waste-developer agitation member includes a flange on an end section of the axle that is on an end close to the fixed wall, the flange being in contact with an end section of the connecting member on a side close to the waste-developer agitation member.

In the above structure, the waste-developer agitation member can bear a thrust load against the fixed wall by contacting the flange with an end section of the connecting member.

Further, in addition to the above structure, a developer-storing container of the present invention may be one in which a space surrounded by the connecting member and the fixed wall is created.

In the above structure, the room surrounded by the connecting member and the fixed wall can be made to act as a pool of developer. Therefore, even if developer migrates to a gap between the fixed wall and the connecting member, the developer can be led to the space, thereby preventing solidification of developer in the gap.

Further, in addition to the above structure, a developer-storing container of the present invention may be one in which a space that is other than a space occupied by the axle and has an aperture on a side opposite to a side close to the fixed wall, is created on a side close to the developer-storing section of the connecting member or in an inner part on a side close to the waste-developer-storing section.

In the above structure, the space in the connecting member can be made to act as a pool of developer. Therefore, even if developer migrates to a gap between the connecting member and the axle in a condition in which the axle on the side of the developer-storing section or on the side of waste-developer-storing section is coupled to the connecting member, the developer can be led to the space, thereby preventing solidification of developer in the gap.

Further, in addition to the above structure, a developer-storing container of the present invention may be one in which the developer agitation member includes a crown-shaped flange having an extension on a side opposite to a side close to the fixed wall, on an end section of the axle that is opposite to an end close to the fixed wall, and a length of the extension is shorter than an axial thickness of a sealing member mounted in between the crown-shaped flange and a wall of the housing of the developer-storing container.

In the above structure, even if the developer agitation member presses the sealing member toward the wall of the housing of the developer-storing container, the sealing member would not be pressed beyond the length of extension of the crown-shaped flange, thereby preventing over-pressing of the sealing member. Further, precision of positioning of the developer agitation member in the direction of thrust is improved.

It will be obvious that the invention thus described may take many variations. Such variations are not to be regarded as a departure from the spirit and scope of the invention, as all such variations would be obvious to one skilled in the art, and are hence intended to be included within the scope of the following claims.

Further, a developer-storing container of the present invention may be preferably used in image forming apparatus employing an electrophotography method.

What is claimed is:

1. A developer-storing container comprising a developer-storing section including a developer agitation member that rotates to agitate developer, and a waste-developer-storing section including a waste-developer agitation member that rotates to agitate waste-developer,
an axle of the developer agitation member and an axle of the waste-developer agitation member being coupled so as to form one axle; and
the developer-storing section and the waste-developer-storing section being partitioned in such a way as to be adjacent to each other in a direction of the axle,
wherein:
the developer-storing section and the waste-developer-storing section are formed by being partitioned by a fixed wall that is fixed to a housing of the developer-storing container in such a way that the developer-storing section and the waste-developer-storing section are adjacent to each other in the direction of the axle; and
the developer agitation member and the waste-developer agitation member are constructably and deconstructably coupled to each other by a connecting member that is slidably, rotatably and detachably interdigitated to a bearing formed on the fixed wall.

2. A developer-storing container as set forth in claim 1, wherein:
the waste-developer agitation member includes a cylindrical flange whose end section has an aperture, on an end section of the axle that is opposite to an end close to the fixed wall;
an axle-supporting member that is interdigitated to an axle-hole formed on a wall of the housing of the developer-storing container, and is mounted in such a way as to extend to an inner part of the waste-developer-storing section, is inserted in the cylindrical flange;
the axle-supporting member is fixed to the wall of the housing, and the cylindrical flange slides and rotates about the axle-supporting member; and
an axial groove is formed on a part of the axle-supporting member that is to be inserted into the cylindrical flange so that the axle-supporting member is partially in contact with the inner face of the cylindrical flange.

3. A developer-storing container as set forth in claim 1, wherein the waste-developer agitation member includes a flange on an end section of the axle that is on an end close to the fixed wall, the flange being in contact with an end section of the connecting member on a side close to the waste-developer agitation member.

4. A developer-storing container as set forth in claim 1, wherein a space surrounded by the connecting member and the fixed wall is created.

5. A developer-storing container as set forth in claim 1, wherein a space that is other than a space occupied by the axle and has an aperture on a side opposite to a side close to the fixed wall, is created on a side close to the developer-storing section of the connecting member or in an inner part on a side close to the waste-developer-storing section.

6. A developer-storing container as set forth in claim 1, wherein the developer agitation member includes a crown-shaped flange having an extension on a side opposite to a side close to the fixed wall, on an end section of the axle that is opposite to an end close to the fixed wall, and a length of the extension is shorter than an axial thickness of a sealing member mounted in between the crown-shaped flange and a wall of the housing of the developer-storing container.

7. A developer-storing container as set forth in claim 1, wherein the developer agitation member includes an agitation sheet that slides on an inner wall of the developer-storing section, and/or the waste-developer agitation member includes an agitation sheet that slides on an inner wall of the waste-developer-storing section.

8. A connecting member for constructing a developer-storing container which comprises: a developer-storing section including a developer agitation member that rotates to agitate developer; and a waste-developer-storing section including a waste-developer agitation member that rotates to agitate waste-developer,
an axle of the developer agitation member and an axle of the waste-developer agitation member being coupled so as to form one axle, and
the developer-storing section and the waste-developer-storing section being formed so as to be adjacent to each other in a direction of the axle,
wherein:
the developer-storing section and the waste-developer-storing section are formed by being partitioned by a fixed wall that is fixed to a housing of the developer-storing container in such a way that the developer-storing section and the waste-developer-storing section are adjacent to each other in the direction of the axle; and
the developer agitation member and the waste-developer agitation member are constructably and deconstructably coupled to each other by the connecting member that is slidably, rotatably and detachably interdigitated to a bearing formed on the fixed wall,
the connecting member comprising an axle that is the same as the axle of the developer agitation member and the axle of the waste-developer agitation member.

9. A developer-storing container comprising:
a fixed wall that is fixed to the developer-storing container and partitions a developer-storing section that includes a developer agitation member that rotates to agitate developer, and a waste-developer-storing section that includes a waste-developer agitation member that rotates to agitate waste-developer; and
a connecting member that is slidably, rotatably, and detachably interdigitated to the bearing formed on the fixed wall,
the developer agitation member and the waste-developer agitation member being detachably interdigitated to the connecting member, respectively, and
an axle of the developer agitation member, an axle of the connecting section, and an axle of the waste-developer agitation member forming one axle.
